(19) United States
(12) Patent Application Publication
(10) Pub. No.: US 2026/0251163 A1
(43) Pub. Date: Aug. 27, 2026

(54) Frame Element Assembly and Method for Securing a Substrate in a Frame Element Assembly

(71) Applicant: Darius A. Povilaitis, Chicago, IL (US)

(72) Inventor: Darius A. Povilaitis, Chicago, IL (US)

(21) Appl. No.: 19/061,326

(22) Filed: Feb. 24, 2025

(51) Int. Cl. F16B 2/06; F16B 35/00; G09F 7/18

(52) U.S. Cl. CPC F16B 2/065; F16B 35/005; G09F 7/18; G09F 2007/1847

(57) ABSTRACT

A frame element assembly includes an elongated body with an open substrate receiving channel and a closed nut receiving passage. A threaded nut is disposed in the closed nut receiving passage and a threaded fastener passes through the closed nut receiving passage, threadably engages the threaded nut, and has a terminal end adapted to protrude into the open substrate receiving channel to engage a substrate within the open substrate receiving channel for securing the substrate therein.

### FIELD OF THE DISCLOSURE

This disclosure relates to frame element assemblies and, more particularly, to frame element assemblies for securing substrates and mounting to structures.

### BACKGROUND

The background provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Mounting systems for rigid substrates, such as signs made from materials like acrylic, plastic, wood, or metal, are common in commercial settings. However, typical mounting systems that involve brackets or frames and threaded members can be complex to install, can damage the substrate during mounting, and can make it difficult to swap out substrates. In addition, the potential loss of small components, such as screws or nuts, during the process of installing and/or changing the substrate poses an ongoing challenge. This not only leads to inconvenience and increased maintenance time but also necessitates the need for replacement parts, thereby incurring additional costs.

### BRIEF SUMMARY OF THE DISCLOSURE

In one example, a frame element assembly includes an elongated body defining an open substrate receiving channel and a closed nut receiving passage, separate from the open substrate receiving channel. A threaded nut is disposed in the closed nut receiving passage and a threaded fastener passes through the closed nut receiving passage, threadably engages the threaded nut, and has a terminal end adapted to protrude into the open substrate receiving channel to engage a substrate within the open substrate receiving channel for securing the substrate therein.

In one implementation, the terminal end of the threaded fastener includes a surface treatment that is configured to prevent removal of the threaded fastener from the threaded nut.

In another implementation, the surface treatment comprises a region of the threaded fastener with a damaged thread, no threads, and/or a bend.

In another implementation, the threaded fastener is one of a finger turn spade screw, a knurled thumb screw, and a headless set screw.

In another implementation, the closed nut receiving passage is disposed between opposing first and second sidewalls of the elongated body and the threaded fastener passes through unthreaded through-holes in the first and second sidewalls.

In another implementation, a diameter of the unthreaded through-holes is larger than a diameter of the threaded fastener.

In another implementation, a cross-sectional shape of the closed nut receiving passage is similar to a cross-sectional shape of the threaded nut.

In another implementation, the second sidewall comprises a contour to define an offset space between the second sidewall and the threaded nut disposed in the closed nut receiving passage. The offset space is configured to receive the terminal end of the threaded fastener with the threaded fastener withdrawn from the unthreaded through-hole in the second sidewall.

In another implementation, the contour in the second sidewall comprises an elongated recess defined in a surface of the second sidewall facing the closed nut receiving passage.

In another implementation, the elongated body comprises a third sidewall disposed opposite the open substrate receiving channel from the second sidewall.

In another implementation, a plurality of protrusions extend from the third sidewall of the elongated body and into the open substrate receiving channel.

In another implementation, the elongated body has a plurality of mounting holes configured to receive threaded mounting members to secure the elongated body to a structure.

In another example, a method includes: inserting a substrate into an open substrate receiving channel of an elongated body of a frame element assembly; inserting a threaded nut into a closed nut receiving passage of the elongated body, separate from the open substrate receiving channel; and inserting a threaded fastener through the closed nut receiving passage, including threading the threaded fastener through the threaded nut, such that a terminal end of the threaded fastener protrudes into the open substrate receiving channel, engages the substrate, and secures the substrate within the open substrate receiving channel.

In one implementation, the method comprises applying a surface treatment to the terminal end of the threaded fastener to prevent removal of the threaded fastener from the threaded nut.

In another implementation, applying a surface treatment to the terminal end of the threaded fastener comprises damaging the terminal end, removing one or more threads, and/or bending the terminal end.

In another implementation, the threaded fastener is one of a finger turn spade screw, a knurled thumb screw, and a headless set screw.

In another implementation, the threaded fastener is a headless set screw and the method comprises threading the headless set screw into the threaded nut such that a leading end of the headless set screw does not protrude from a sidewall of the elongated body with the headless set screw engaging the substrate and securing the substrate within the open substrate receiving channel.

In another implementation, the method comprises passing the threaded fastener through unthreaded through-holes defined in opposing first and second sidewalls of the elongated body, where the closed nut receiving passage disposed between the first and second sidewalls.

In another implementation, the method comprises partially unthreading the threaded fastener from the threaded nut such that the terminal end of the threaded fastener disengages the substrate to allow removal of the substrate from the open substrate receiving channel, the terminal end is withdrawn from the open substrate receiving channel, and the threaded fastener maintains threaded engagement with the threaded nut.

In another implementation, the terminal end of the threaded fastener is positioned in an offset space in the closed nut receiving passage, the offset space defined by a contour in the second sidewall of the elongated body.

Advantages will become more apparent to those of ordinary skill in the art from the following description of the examples, which have been shown and described by way of illustration. As will be realized, the present examples may be capable of other and different implementations, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 illustrates a side view of an example frame element assembly secured to a structure and having a substrate secured therein;

FIG. 2 illustrates a cross-sectional view the frame element assembly, structure, and substrate of FIG. 1, taken along line 2 -2 in FIG. 1;

FIG. 3 illustrates the cross-sectional view of FIG. 2 with an alternative threaded fastener;

FIG. 4 illustrates a front view of the frame element assembly of FIG. 1;

FIG. 5 illustrates a cross-sectional view of the frame element assembly of FIG. 4, taken along line 5 -5 of FIG. 4;

FIG. 6 illustrates the cross-sectional view of FIG. 5 with the threaded fastener withdrawn; and

FIG. 7 illustrates an example method of securing a substrate with a frame element assembly.

### DETAILED DESCRIPTION

The example frame element assemblies and method disclosed herein address the drawbacks noted above. For example, the example frame element assemblies are designed to securely hold various types of substrates, preferably rigid substrates such as acrylic, plastic, signs, corrugated signs, wood, and metal, for mounting on diverse structures, including poles, awnings, roofs, walls, ceilings, etc. The example frame element assemblies have an elongated body that features an open substrate receiving channel to receive the substrate and a closed nut receiving passage that houses a threaded nut. A threaded fastener, which can be a finger turn spade screw, a knurled thumb screw, a headless set screw, etc., passes through the closed nut receiving passage and is threaded through the threaded nut such that a terminal end of the threaded fastener is designed to protrude into the open channel, thereby engaging and securing the substrate within.

The terminal end of the threaded fastener can include a surface treatment, such as a deformed portion, a damaged thread, no threads, or a bend, which is configured to prevent the removal of the threaded fastener from the threaded nut. This feature ensures that the threaded fastener remains attached to the frame element assembly, reducing the risk of loss and making the process of changing substrates more efficient and less cumbersome. An offset space can also be defined by a contour in a sidewall that partially defines the closed nut receiving passage, in which the terminal end of the threaded fastener can retract when partially unthreaded. This allows the terminal end of the threaded fastener to be retracted from the open substrate receiving channel, allowing for the easy removal and replacement of substrates, without the risk of completely detaching and losing the fastener and/or the threaded nut. The offset space can also contribute to the overall aesthetic of the frame element assembly by minimizing the protrusion of the threaded fastener when not in use.

The closed nut receiving passage has a cross-sectional shape that mirrors the shape of the threaded nut, ensuring a snug fit and stable positioning of the nut within the closed nut receiving passage. Moreover, this allows the closed nut receiving passage to maintain the orientation of the threaded nut such that the threaded nut does not rotate when the threaded fastener is rotated (e.g., tightened and/or loosened). This stability assists in maintaining the integrity of the substrate securing mechanism, especially in environments where the assembly may be subject to vibrations or other forces.

The present frame element assemblies and method provide a robust and user-friendly frame element assembly that offers significant improvements in terms of substrate retention, assembly stability, and ease of substrate replacement. They also address a potential problem of the loss of the threaded fasteners and/or the threaded nuts.

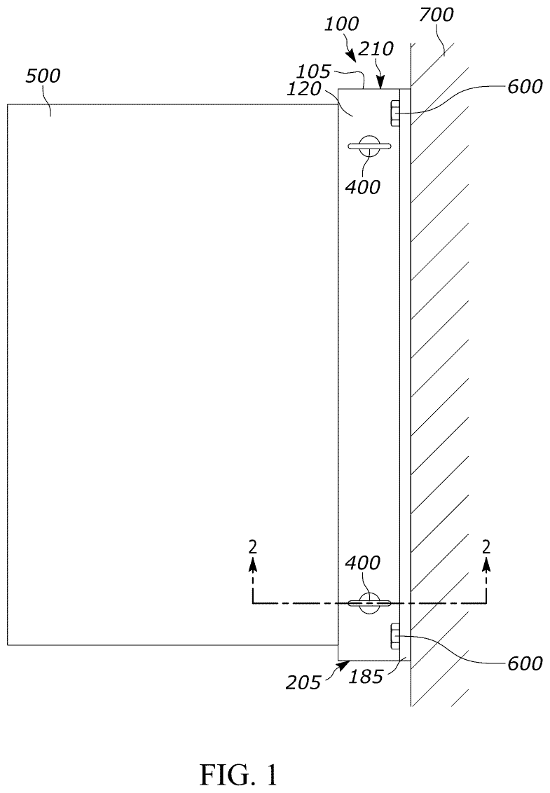

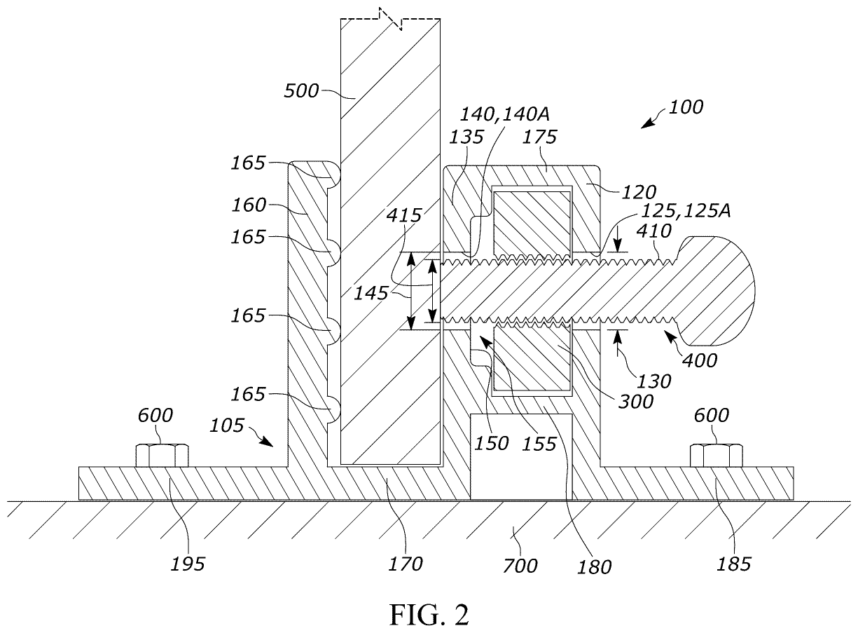

Referring to FIGS. 1-2, an example frame element assembly 100 is illustrated secured to a structure 700 and having a substrate 500 secured therein. Substrate 500 (e.g., signs, instructions, directions, advertisements, flags, etc.) can be any suitable substrate and can, in some implementations, be a rigid substrate, such as acrylic, plastic, wood, or metal. Other substrates are also possible. Structure 700 can be any type of structure to which a user may want to mount a substrate, such as a pole, an awning, a wall, a roof, or a ceiling. Other structures are also possible.

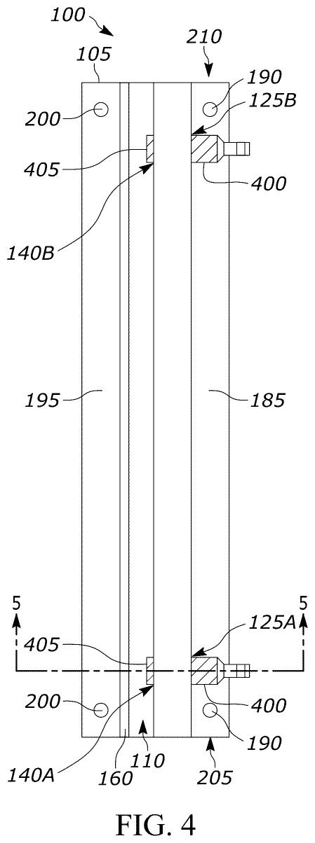

Referring to FIGS. 4-6, frame element assembly 100 generally includes an elongated body 105, a threaded nut 300, and a threaded fastener 400. In the example shown, elongated body 105 is a single, integral, unitary part, such as an extruded aluminum part. In other implementations, elongated body 105 could comprise multiple pieces that are secured together, can be made by other manufacturing means, and could be made of any material that would be appropriate for a given application. In addition, in the example shown, a back surface 215 of elongated body 105 is generally planar, which can allow mounting of elongated body 105 to generally planar structures, such as walls, roofs, ceilings, etc. In other implementations, back surface 215 could be arcuate to allow mounting of elongated body 105 to curved structures, such as poles, or could have any shape/contour desired to allow mounting of elongated body 105 to any desired structure.

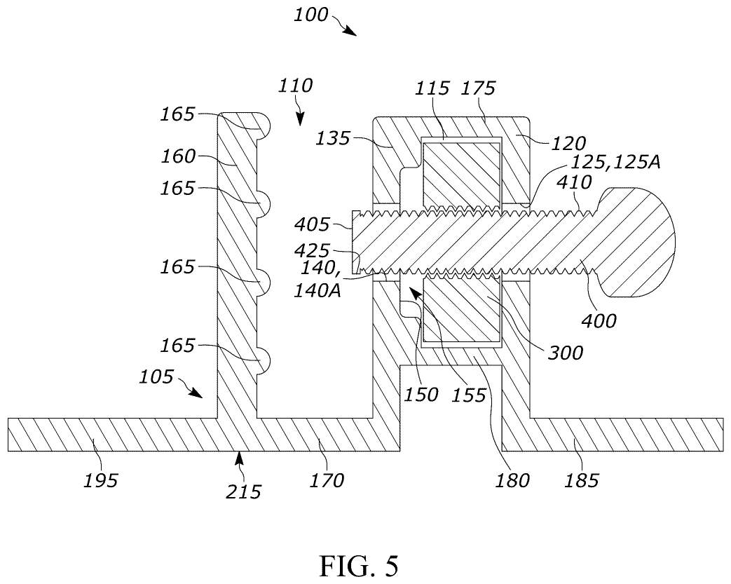

With reference to FIG. 5, elongated body 105 includes a first sidewall 120, a second sidewall 135 that is generally parallel to and offset from first sidewall 120, and a third sidewall 160 that is generally parallel to and offset from first sidewall 120 and second sidewall 135.

Elongated body 105 defines an open substrate receiving channel 110, which is disposed between second sidewall 135 and third sidewall 160 and is generally defined by second sidewall 135, third sidewall 160, and a back wall 170. Third sidewall 160 is disposed opposite open substrate receiving channel 110 from second sidewall 135 and can have a plurality of protrusions 165 that extend from third sidewall 160 into open substrate receiving channel 110. Plurality of protrusions 165 can include elongated ribs extending partially or wholly along the length of open substrate receiving channel 110 and/or can include nubs positioned partially or wholly along the length of open substrate channel 110. Other geometries are possible. Plurality of protrusions 165 can be configured to engage substrate 500 and assist in retention of substrate 500 in open substrate receiving channel 110.

Elongated body 105 also defines a closed nut receiving passage 115, separate from open substrate receiving channel 110. Closed nut receiving passage 115 is disposed between first sidewall 120 and second sidewall 135 and is generally defined by first sidewall 120, second sidewall 135, a top wall 175 that extends between first sidewall 120 and second sidewall 135, and a bottom wall 180 that extends between first sidewall 120 and second sidewall 135 and is generally parallel to and offset from top wall 175. Closed nut receiving passage 115 has a cross-sectional shape that is similar to, but slightly larger than, a cross-sectional shape of threaded nut 300, such that the threaded nut 300 can be inserted into closed nut receiving passage 115 and disposed within closed nut receiving passage 115. In the example shown, threaded nut 300 is a square nut with a rectangular cross-section (as seen in FIG. 5) and closed nut receiving passage 115 is an elongated rectangular cavity having a rectangular cross-section (as seen in FIG. 5) that is complimentary to the rectangular cross-section of threaded nut 300. So configured, when threaded nut 300 is disposed in closed nut receiving passage 115, top wall 175 and bottom wall 180 can engage and resist rotation of threaded nut 300, thereby facilitating advancement and retraction of threaded fastener 400. In other implementations, threaded nut 300 could include a hexagonal nut or other nut capable of being retained in its rotational orientation by closed nut receiving passage 115. Threaded nut 300 includes internal threads that match external threads on threaded fastener 400. In other implementations, threaded nut 300 can be any type of threaded nut that can be disposed in closed nut receiving passage 115 and that can receive and retain threaded fastener 400, as described below.

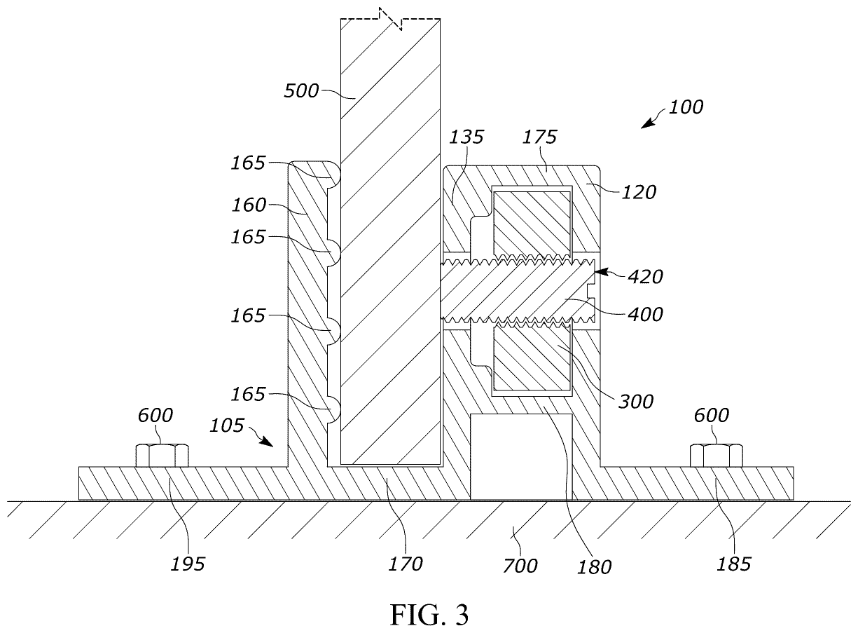

Threaded fastener 400 can be any type of threaded fastener, for example, a finger turn spade screw, a knurled thumb screw, a headless set screw, etc., that has threads 410 that threadably engage threaded nut 300. In the examples shown in FIGS. 1-2 and 4-6, threaded fastener 400 is illustrated as a finger turn spade screw. In another implementation, such as that shown in FIG. 3, threaded fastener 400 can be a headless set screw and can be configured such that a leading edge 420 of the headless set screw does not protrude from first sidewall 120 with the headless set screw engaging substrate 500 and securing substrate 500 within open substrate receiving channel 110.

With continued reference to FIGS. 2 and 5, threaded fastener 400 passes through an unthreaded through-hole 125 in first sidewall 120, through closed nut receiving passage 115 where it is threaded through threaded nut 300, and through an unthreaded through-hole 140 in second sidewall 135 such that a terminal end 405 of threaded fastener 400 can protrude into open substrate receiving channel 110 to engage substrate 500 (see, FIG. 2) within open substrate receiving channel 110 for securing substrate 500 therein. Unthreaded through-hole 125 and unthreaded through-hole 140 each have a diameter 130, 145, respectively, that is larger than a diameter 415 of threaded fastener 400 (e.g., an outer diameter of the threaded portion of threaded fastener 400). In the implementation shown in FIGS. 1 and 4, for example, first sidewall 120 has a first unthreaded through-hole 125A positioned approximately 1.25 inches from a first end 205 of elongated body 105 and a second unthreaded through-hole 125B positioned approximately 1.25 inches from a second end 210 of elongated body 105. Similarly, second sidewall 135 has a first unthreaded through-hole 140A (axially aligned with first unthreaded through-hole 125A) positioned approximately 1.25 inches from first end 205 of elongated body 105 a second unthreaded through-hole 140B (axially aligned with second unthreaded through-hole 125B) positioned approximately 1.25 inches from second end 210 of elongated body 105. In other implementations, first unthreaded through-holes 125A, 140A and second unthreaded through-holes 125B, 140B can be positioned any distance from the ends of elongated body 105.

Terminal end 405 of threaded fastener 400 can include a surface treatment 425 that is configured to prevent removal of threaded fastener 400 from threaded nut 300 after threaded fastener 400 has been threaded into threaded nut 300. This prevents threaded fastener 400 from being completely removed and lessens the chance of losing threaded fastener 400, for example, during removal or replacement of substrate 500. In some implementations, the surface treatment 425 could be a region of threaded fastener 400 that is deformed or has threads 410 that are damaged, a region of threaded fastener 400 having no threads, or a region of threaded fastener 400 having a bend to prevent the region of threaded fastener 400 from being removed from threaded nut 300. Other surface treatments are also possible.

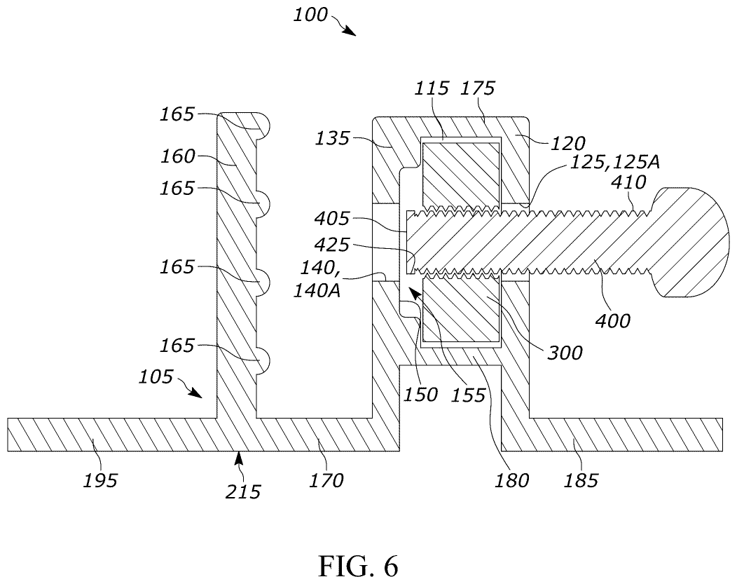

To allow terminal end 405 of threaded fastener 400 to be fully removed from open substrate receiving channel 110 for efficient removal and insertion of substrate 500 while still keeping threaded fastener 400 threaded through threaded nut 300, second sidewall 135 can include a contour 150 that defines an offset space 155 between second sidewall 135 and threaded nut 300 disposed in closed nut receiving passage 115. Offset space 155 can be an elongated recess defined in a surface of second sidewall 135 facing closed nut receiving passage 115 and, as shown in FIG. 6, can be configured to receive terminal end 405 of threaded fastener 400 with threaded fastener 400 withdrawn from unthreaded through-hole 140 of second sidewall 135.

To allow mounting of elongated body 105 to structure 700, elongated body 105 can have a first flange 185 extending from first sidewall 120 and a second flange 195 extending from third sidewall 160. First flange 185 can include a plurality of mounting holes 190 and second flange 195 can include a plurality of mounting holes 200. As shown in FIGS. 1-3, plurality of mounting holes 190 and plurality of mounting holes 200 are configured to receive mounting members 600 (e.g., threaded fasteners, rivets, nails, etc.) to secure elongated body 105 to structure 700. In the example shown, first flange 185 has two mounting holes 190, each approximately ¼ inch in diameter and each positioned approximately¾ inch from a respective end of elongated body 105. Similarly, second flange 195 has two mounting holes 200, each approximately ¼ inch in diameter and each positioned approximately ¾ inch from a respective end of elongated body 105. In other implementations, mounting holes 190 and mounting holes 200 can be positioned any distance from the ends of elongated body 105.

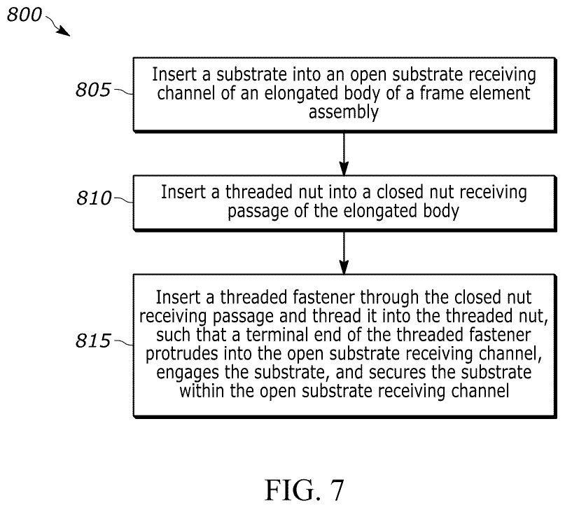

Referring to FIG. 7, an example method 800 the installation of a substrate into a frame element assembly is illustrated.

At step 805 of method 800, a substrate (e.g., substrate 500) is inserted into an open substrate receiving channel (e.g., open substrate receiving channel 110) of an elongated body (e.g., elongated body 105) of a frame element assembly (e.g., frame element assembly 100).

At step 810, a threaded nut (e.g., threaded nut 300) is inserted into a closed nut receiving passage (e.g., closed nut receiving passage 115) of the elongated body, which is separate from the open substrate receiving channel.

At step 815, a threaded fastener (e.g., threaded fastener 400) is inserted through the closed nut receiving passage and the threaded fastener is threaded through the threaded nut in the closed nut receiving passage such that a terminal end (e.g., terminal end 405) of the threaded fastener protrudes into the open substrate receiving channel and engages and secures the substrate within the open substrate receiving channel. The threaded fastener can be a finger turn spade screw, a knurled thumb screw, a headless set screw, etc. In some implementations, the threaded fastener can pass through an unthreaded through-hole (e.g., unthreaded through-hole 125) in a first sidewall (e.g., first sidewall 120) of the elongated body and through an unthreaded through-hole (e.g., unthreaded through-hole 140) in a second sidewall (e.g., second sidewall 135) of the elongated body, where the closed nut receiving passage is disposed between the first sidewall and the second sidewall. In one implementation, the threaded fastener can be a headless set screw and the headless set screw can be threaded into the threaded nut such that a leading end of the headless set screw does not protrude from the first sidewall with a trailing end of the headless set screw engaging the substrate and securing the substrate within the open substrate receiving channel.

In some implementations, method 800 can include the step of applying a surface treatment (e.g., surface treatment 425) to the terminal end of the threaded fastener to prevent the removal of the threaded fastener from the threaded nut. This can include deforming and/or damaging the terminal end of the threaded fastener (e.g., bending or damaging one or more threads), removing one or more threads from the threaded fastener, bending the terminal end of the threaded fastener, etc. In some implementations, the step of inserting a substrate into the open substrate receiving channel occurs after applying a surface treatment to the terminal end of the threaded fastener.

To remove the substrate from the frame element assembly, method 800 can include the step of partially unthreading the threaded fastener from the nut such that the terminal end of the threaded fastener disengages the substrate to allow removal of the substrate from the open substrate receiving channel (see, e.g., FIG. 6). The terminal end can be withdrawn from the open substrate receiving channel and the threaded fastener can maintain threaded engagement with the threaded nut. A contour (e.g., contour 150) in the second sidewall can define an offset space (e.g., offset space 155) and the terminal end of the threaded fastener can be positioned in the offset space while the substrate is removed and/or replaced.

The frame element assembly can be mounted to the structure by inserting a plurality of threaded mounting members (e.g., threaded mounting members 600) through mounting holes (e.g., plurality of mounting holes 190 and plurality of mounting holes 200) in flanges (e.g., first flange 185 and second flange 195) of the elongated body and threading the plurality of mounting members into the structure.

Those skilled in the art will recognize that a wide variety of modifications, alterations, and combinations can be made with respect to the above described examples without departing from the spirit and scope of the invention(s) disclosed herein, and that such modifications, alterations, and combinations are to be viewed as being within the ambit of the inventive concept(s).

What is claimed is:

1. A frame element assembly, comprising:
an elongated body defining an open substrate receiving channel and a closed nut receiving passage, separate from the open substrate receiving channel;
a threaded nut disposed in the closed nut receiving passage; and
a threaded fastener passing through the closed nut receiving passage, threadably engaging the threaded nut, and having a terminal end adapted to protrude into the open substrate receiving channel to engage a substrate within the open substrate receiving channel for securing the substrate therein.

2. The frame element assembly of claim 1, wherein the terminal end of the threaded fastener includes a surface treatment that is configured to prevent removal of the threaded fastener from the threaded nut.

3. The frame element assembly of claim 2, wherein the surface treatment comprises a region of the threaded fastener with a damaged thread, no threads, and/or a bend.

4. The frame element assembly of claim 1, wherein the threaded fastener is one of a finger turn spade screw, a knurled thumb screw, and a headless set screw.

5. The frame element assembly of claim 1, wherein the closed nut receiving passage is disposed between opposing first and second sidewalls of the elongated body, and wherein the threaded fastener passes through unthreaded through-holes in the first and second sidewalls.

6. The frame element assembly of claim 5, wherein a diameter of the unthreaded through-holes is larger than a diameter of the threaded fastener.

7. The frame element assembly of claim 1, wherein a cross-sectional shape of the closed nut receiving passage is similar to a cross-sectional shape of the threaded nut.

8. The frame element assembly of claim 5, wherein the second sidewall comprises a contour to define an offset space between the second sidewall and the threaded nut disposed in the closed nut receiving passage, the offset space configured to receive the terminal end of the threaded fastener with the threaded fastener withdrawn from the unthreaded through-hole in the second sidewall.

9. The frame element assembly of claim 8, wherein the contour in the second sidewall comprises an elongated recess defined in a surface of the second sidewall facing the closed nut receiving passage.

10. The frame element assembly of claim 5, wherein the elongated body further comprises a third sidewall disposed opposite the open substrate receiving channel from the second sidewall.

11. The frame element assembly of claim 10, further comprising a plurality of protrusions extending from the third sidewall of the elongated body and into the open substrate receiving channel.

12. The frame element assembly of claim 1, wherein the elongated body has a plurality of mounting holes configured to receive threaded mounting members to secure the elongated body to a structure.

13. A method, comprising:
inserting a substrate into an open substrate receiving channel of an elongated body of a frame element assembly;
inserted a threaded nut into a closed nut receiving passage of the elongated body, separate from the open substrate receiving channel; and
inserting a threaded fastener through the closed nut receiving passage, including threading the threaded fastener through the threaded nut, such that a terminal end of the threaded fastener protrudes into the open substrate receiving channel, engages the substrate, and secures the substrate within the open substrate receiving channel.

14. The method of claim 13, comprising applying a surface treatment to the terminal end of the threaded fastener to prevent removal of the threaded fastener from the threaded nut.

15. The method of claim 14, wherein applying a surface treatment to the terminal end of the threaded fastener comprises damaging the terminal end, removing one or more threads, and/or bending the terminal end.

16. The method of claim 13, wherein the threaded fastener is one of a finger turn spade screw, a knurled thumb screw, and a headless set screw.

17. The method of claim 13, wherein the threaded fastener is a headless set screw and the method comprises threading the headless set screw into the threaded nut such that a leading end of the headless set screw does not protrude from a sidewall of the elongated body with the headless set screw engaging the substrate and securing the substrate within the open substrate receiving channel.

18. The method of claim 13, comprising passing the threaded fastener through unthreaded through-holes defined in opposing first and second sidewalls of the elongated body, the closed nut receiving passage disposed between the first and second sidewalls.

19. The method of claim 18, comprising partially unthreading the threaded fastener from the threaded nut such that the terminal end of the threaded fastener disengages the substrate to allow removal of the substrate from the open substrate receiving channel, the terminal end being withdrawn from the open substrate receiving channel and the threaded fastener maintaining threaded engagement with the threaded nut.

20. The method of claim 19, wherein the terminal end of the threaded fastener is positioned in an offset space in the closed nut receiving passage, the offset space defined by a contour in the second sidewall of the elongated body.
